(19) United States
(12) Patent Application Publication
(10) Pub. No.: US 2026/0203136 A1
(43) Pub. Date: Jul. 16, 2026

(54) AIRCRAFT AVIONICS DEVICE WITH MANAGEMENT PARTITION FOR DOWNLOADING NON-CRITICAL AND/OR CRITICAL FUNCTION(S), AIRCRAFT, AND ASSOCIATED FLEET OF AIRCRAFT

(71) Applicant: THALES, Meudon (FR)

(72) Inventor: Jérémy MAURICE, SEYSSES (FR)

(21) Appl. No.: 19/448,323

(22) Filed: Jan. 14, 2026

(30) Foreign Application Priority Data
Jan. 14, 2025 (FR) 25 00379

(51) Int. Cl. G06F 9/50

(52) U.S. Cl. CPC G06F 9/5077; G06F 2209/5021

(57) ABSTRACT

This invention relates to an avionics device comprising at least hardware resources storing a hypervisor configured to: generate at least one critical software partition associated with at least a portion of the resources and configured to execute a critical software function, generate at least one non-critical software partition associated with at least a portion of the resources and configured to execute a non-critical software function, execute, over a predefined duration, the partitions by allocating to them at least a portion of the associated resources, generate and execute a management software partition configured to: receive at least one software function and store it in the resources, replace the function of the partitions with a stored function, and instruct the hypervisor to execute, over the predefined duration, the partitions

### CROSS-REFERENCE TO RELATED APPLICATIONS

This application is a U.S. non-provisional application claiming the benefit of French Application No. 25 00379, filed on January 14, 2025, which is incorporated herein by reference in its entirety.

### FIELD

This invention relates to an electronic avionics device intended to be on board an aircraft.

The invention also relates to an aircraft equipped with such a processing device.

The invention also relates to a fleet of such aircraft.

### BACKGROUND

Onboard electronic devices in aircraft play a central role in managing the vital functions of said aircraft. For example, such functions manage flight control, navigation, onboard systems management, and communication. These functions can be divided into two main categories: critical functions, which are essential for the safety of the aircraft and its occupants, and non-critical functions, which provide additional services but do not directly affect the safety or essential operation of the aircraft.

Traditional avionics devices are often segmented, or compartmentalized, with critical and non-critical functions operating on separate architectures to minimize interference risks and ensure strict separation between these two types of functions.

However, such segmentation increases the complexity, cost, and weight of aircraft.

Moreover, such segmentation requires the pilot to interface between the world of critical functions and the world of non-critical functions, thus increasing the risk of human errors.

Furthermore, such segmentation does not offer different deployment modes, such as single-equipment in an aircraft, multi-equipment in an aircraft, single-equipment multi-aircraft, or multi-equipment multi-aircraft.

It also does not offer onboard/ground deployment to manage aircraft fleets.

### SUMMARY

The purpose of the invention is to propose an electronic avionics device intended to be on board an aircraft and capable of addressing the above issues.

To this end, the present invention aims at an electronic avionics device intended to be on board an aircraft, said avionics device comprising at least:

a communication unit configured to exchange data with electronic equipment,

hardware resources comprising: computing resources, network resources, data storage resources comprising at least a first memory space wherein a hypervisor is stored.

According to other advantageous aspects of the invention, the avionics device comprises one or more of the following features taken alone or in any possible combination:

the management software partition is further configured to delete at least one non-critical software partition and/or at least one critical software partition associated with the non-critical function and/or the critical function that has been replaced,

the management software partition is further configured to modify the scheduling based on at least one priority criterion associated with at least one critical software partition and/or at least one non-critical software partition,

the at least one priority criterion is an execution time criterion, a priority that can be set by an operator, or the possibility of execution in multiple execution cycles,

the management software partition is further configured to determine at least one execution parameter representative of the execution quality of the non-critical function of at least one non-critical software partition and/or the critical function of at least one critical software partition, the at least one execution parameter also being a priority criterion,

the hypervisor is configured to generate at least two critical or non-critical software partitions,

the management software partition is further configured to allow data exchanges between at least two critical or non-critical software partitions according to at least one exchange criterion,

the at least one exchange criterion is a criterion of availability, integrity, and/or confidentiality between at least two non-critical software partitions,

the scheduling is adapted to guarantee the execution of at least one critical software partition and at least one management software partition (48) over the predefined duration,

the computing resources include critical computing resources and non-critical computing resources previously set, with at least one critical software partition and the management software partition being associated with the critical computing resources, and at least one non-critical software partition being associated with the non-critical computing resources,

the critical computing resources further include management computing resources and avionics computing resources previously set, with the management software partition being associated with the management computing resources and at least one critical software partition being associated with the avionics computing resources,

a communication gateway between at least one critical software partition and at least one non-critical software partition, said communication gateway being configured to: allow data exchange between at least one critical software partition and at least one non-critical software partition according to at least one exchange criterion, verify the integrity and/or confidentiality of said data exchange, and interrupt the data exchange if the associated integrity and/or confidentiality is not verified, the communication gateway being preferably included in the hypervisor or external to the avionics device,

wherein the non-critical function intended to be executed by at least one non-critical software partition is included in a container including at least one ancillary function, the non-critical function requiring at least one ancillary function to be executed.

The present invention aims at an aircraft comprising an avionics device as defined above.

The present invention aims at a fleet of aircraft configured to exchange processing data or a software service, with at least one aircraft of said fleet including an avionics device as defined above; preferably, all aircraft of said fleet include said avionics device.

### BRIEF DESCRIPTION OF THE DRAWINGS

The invention will become clearer upon reading the following description, given solely by way of non-limiting example and made with reference to the drawings wherein:

FIG. 1 is a schematic representation of an electronic avionics device intended to be on board an aircraft and communicating with external electronic equipment;

FIG. 2 is a schematic representation of a software architecture generated by the avionics device;

FIG. 3 is a schematic representation of one embodiment of the avionics device;

FIG. 4 is a schematic representation of a second embodiment of the avionics device;

FIG. 5 is a schematic representation of an aircraft including a plurality of avionics devices according to the invention; and

FIG. 6 is a schematic representation of a fleet of aircraft, each equipped with an avionics device according to the invention.

### DETAILED DESCRIPTION

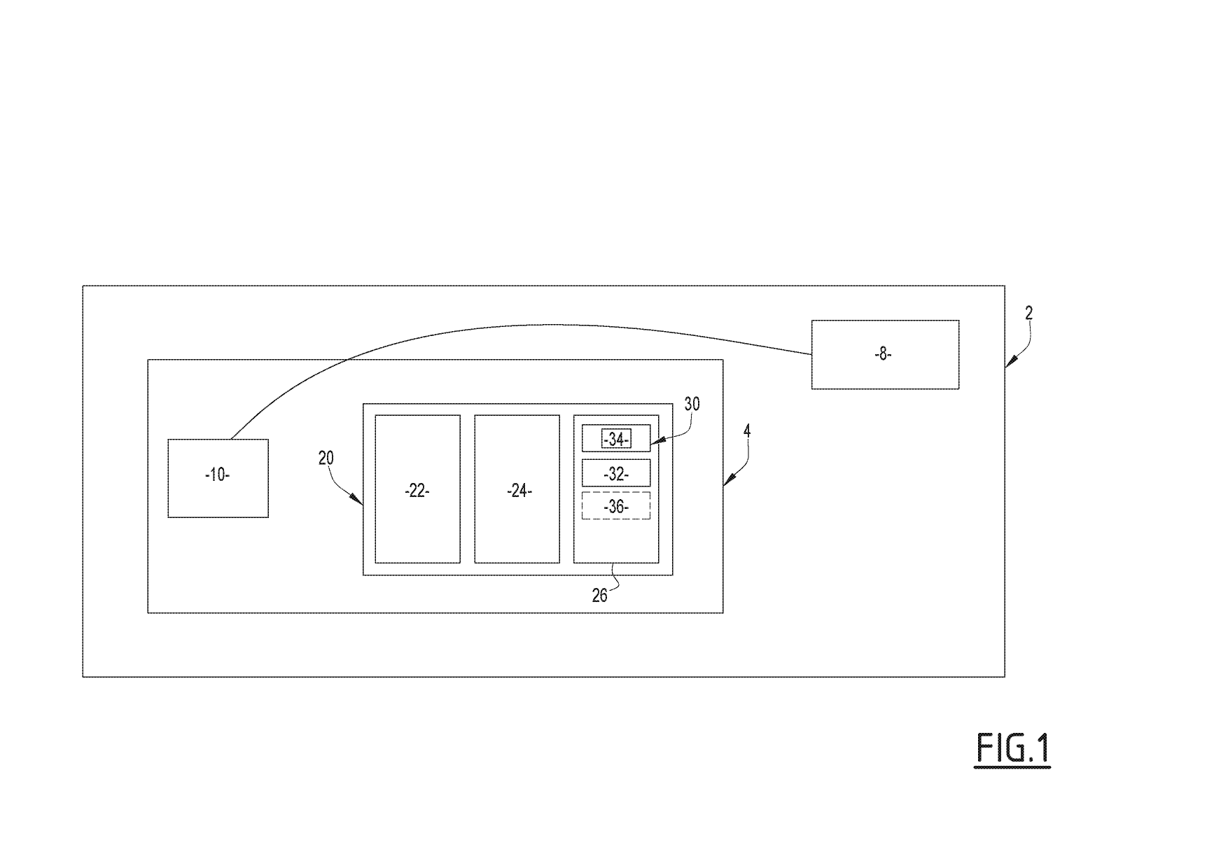

In FIG. 1, an aircraft 2 includes an electronic avionics device 4 communicating with electronic equipment 8.

Typically, the electronic equipment 8 is an internal or external server to the aircraft 2.

The avionics device 4 includes at least a communication unit 10 and hardware resources 20.

The communication unit 10 is configured to communicate with electronic equipment 8 and exchange data with said electronic equipment 8.

The communication unit 10 is also configured to transfer the data received during such a data exchange to the hardware resources 20.

The hardware resources 20 include at least computing resources 22, network resources 24, and data storage resources 26.

Typically, the computing resources 22 include at least a graphics processing unit or GPU, a tensor processing unit or TPU, a data processing unit or DPU, a neural processing unit or NPU, and/or a central processing unit or CPU, for example, one or more processors.

Each processor is, for example, a single-core processor or a multi-core processor.

Preferably, the computing resources 22 include at least one CPU.

Typically, the network resources 24 include one or more network cards.

Typically, the data storage resources 26 include magnetic media, such as hard drives, solid-state media, such as HDDs (Hard Disk Drives) and/or SSDs (Solid State Drives), removable media, such as USB keys and SD cards, and/or optical discs, such as CDs and DVDs.

For example, the data storage resources 26 are random access memory or RAM.

RAM is a type of volatile memory used in computer systems to temporarily store data and instructions needed by the processor during program execution. RAM is composed of integrated circuits capable of reading and writing data quickly, but it loses its content when the power is cut off.

Optionally, the data storage resources 26 are flash memory resources.

Flash memory is a type of non-volatile memory and therefore retains data even without power, typically based on semiconductor technology that uses floating-gate memory cells.

The data storage resources 26 include at least a first memory space 30 and a second memory space 32, said second memory space 32 being distinct from the first memory space 30.

The first memory space 30 is configured to store a hypervisor 34.

The hypervisor 34 is software adapted to generate and execute software partitions.

In the following description, a software partition refers to a set consisting of hardware resource allocation(s) and an associated software function, with the temporary allocation(s) of hardware resources being preferably temporary.

The hypervisor 34 allows multiple software partitions to operate simultaneously from the same hardware resources by distributing, at a given time, the hardware resources among said software partitions, each hardware resource being allocated to a single respective software partition at a given time.

For example, the software partitions generated and executed by the hypervisor 34 are certified by the ARINC 653 standard.

ARINC 653 is a standard developed by Aeronautical Radio, Incorporated (ARINC), primarily used in avionics and safety-critical embedded systems, such as integrated modular avionics (IMA) systems. This standard aims to ensure that multiple applications with different levels of criticality can operate on the same hardware platform while adhering to strict safety constraints.

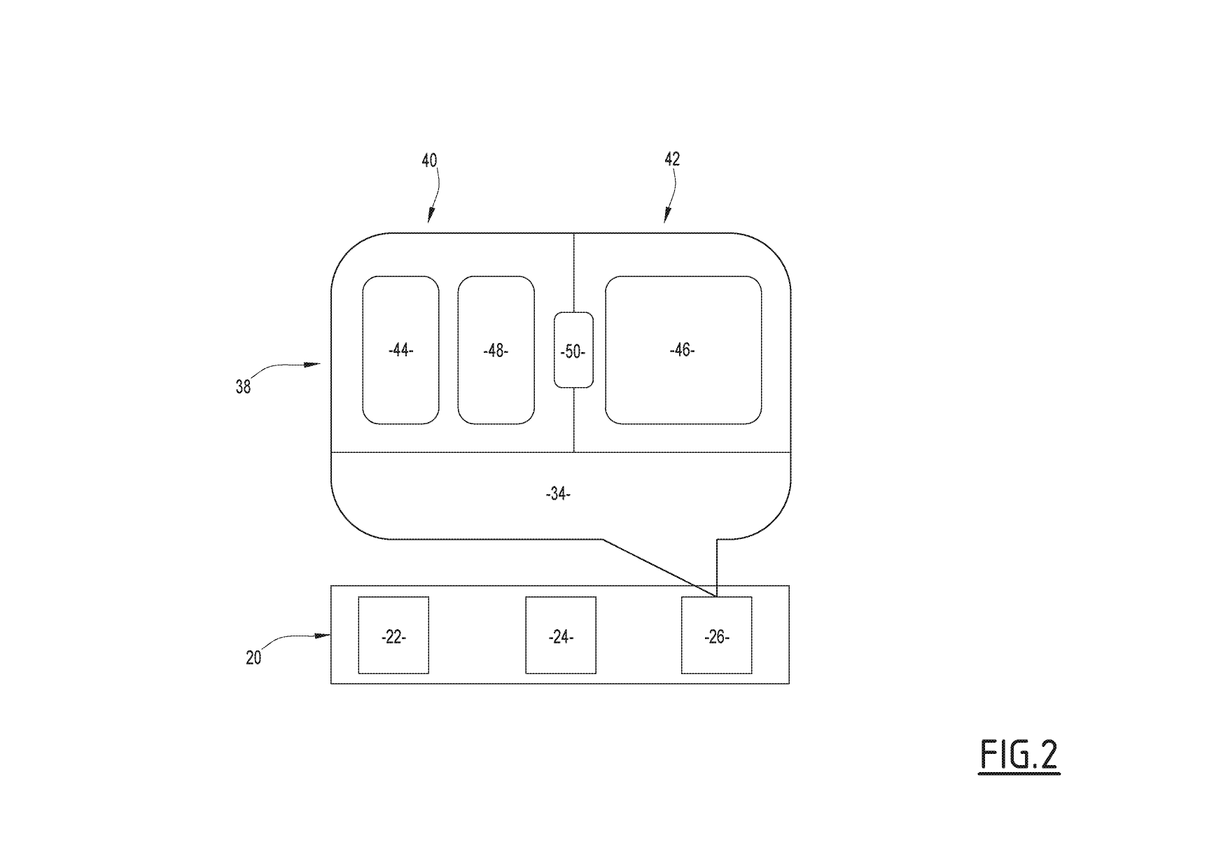

As shown in FIG. 2, the hypervisor 34 is configured to generate a software architecture 38 compartmentalized into an avionics domain 40 and an open domain 42.

The avionics domain 40 is a domain corresponding to the highest safety level on board the aircraft 2, particularly the highest required safety level of the avionics device 4 of the aircraft 2.

The open domain 42 is a domain corresponding to a lower safety level than the safety level of the avionics domain 40.

The hypervisor 34 is configured to generate at least one critical software partition 44, with at least one critical software partition 44 being a software partition whose associated software function is classified as critical by an operator.

A critical software function is a function whose malfunction poses a risk to the safety and/or security of the aircraft 2.

Typically, at least one critical software partition 44 belongs to the avionics domain 40.

A critical software function is hosted within an operating system in the data storage resources 26.

Typically, critical software functions are legacy functions that do not involve a container in their hosting within the operating system.

At least one critical software partition 44 is configured to execute the critical software function using at least a portion of the associated hardware resources 20.

For example, the critical software function is a communication function with air traffic control (ATC), a trajectory calculation function for the aircraft 2, or an actuator control function on board the aircraft 2.

Optionally, at least one critical software partition 44 is certified according to a DAL (Design Assurance Level), typically DAL A, DAL B, or DAL C according to the DO-178 standard.

The DO-178 standard is an international standard developed by RTCA (Radio Technical Commission for Aeronautics) to guide the development and certification of embedded software in civil aviation.

The DO-178 standard defines five certification levels, ordered below by decreasing criticality level: DAL A, DAL B, DAL C, DAL D, and DAL E, with DAL A being the highest criticality level and DAL E being the lowest criticality level.

A DAL A certification level corresponds to equipment whose failure could lead to the loss of the aircraft or human lives.

A DAL B certification level corresponds to equipment whose failure could severely compromise flight safety or cause serious injuries.

A DAL C certification level corresponds to equipment whose failure could cause significant degradation of aircraft performance but without immediate safety risk.

A DAL D certification level corresponds to equipment whose failure would only slightly affect aircraft performance.

A DAL E certification level corresponds to equipment whose failure would have no impact on safety or aircraft performance.

The hypervisor 34 is configured to generate at least one non-critical software partition 46 using at least a portion of the associated hardware resources 20.

At least one non-critical software partition 46 is a software partition whose associated software function is classified as non-critical by the operator.

A non-critical software function is a function whose malfunction does not pose a risk to the safety of the aircraft 2.

Typically, at least one non-critical software partition 46 belongs to the open domain 42.

A non-critical software function is also hosted within an operating system in the data storage resources 26.

Typically, the function associated with at least one non-critical software partition 46 is included in a container including at least one ancillary function, with the non-critical function requiring at least one ancillary function to be executed.

These are referred to as "cloud-native" functions, and at least one ancillary function allows the implementation of a microservices architecture within the container itself.

Typically, the container also contains an orchestrator configured to manage and automate the deployment, scaling, monitoring, and management of the container.

For example, the orchestrator is a Kubernetes orchestrator.

Kubernetes is a widely deployed open-source orchestrator available in several versions, such as K8S, K3S, Rancher Kubernetes Engine, OpenShift, or AKS.

Typically, the non-critical software function is a multimedia content distribution function to passengers on board the aircraft 2, a light indicator management function for said passengers, or an internet connection distribution function for said passengers.

Typically, a non-critical software function is of the "Best-Effort" type, meaning it operates on a principle where it attempts to provide a service in the best possible way, without performance, quality of service, or data delivery guarantees.

For this type of non-critical function, there is no formal commitment to provide a certain level of reliability, latency, or bandwidth. The hardware resources 20 are used opportunistically: data is sent in the hope that it will reach its destination, but no guarantee is given in case of network congestion, packet loss, or other issues.

Optionally, at least one non-critical software partition 46 is certified DAL D or DAL E according to the DO-178 standard.

Typically, the operator predefines several sizes of non-critical software partitions 46 among: XS (extra small), S (small), M (medium), L (large), or XL (extra large).

A software partition size corresponds to an amount of hardware resources 20 allocated to said software partition.

Thus, defining such sizes of non-critical software partitions 46 makes it possible to replace non-critical software functions without completely restarting the avionics device 4 (and thus the critical software partitions).

Furthermore, the hypervisor 34 is configured to execute, over a predefined duration, at least one critical software partition 44 and at least one non-critical software partition 46 by allocating to each partition at least a portion of the associated hardware resources 20 and according to a predetermined scheduling.

Typically, the predefined duration is between 1 millisecond and 10 seconds.

The predefined duration is set by the operator based on the context of use of the avionics device 4.

The scheduling corresponds to an execution plan of the different partitions one after the other over the predefined duration.

Alternatively, the scheduling is adapted to guarantee the execution of at least one critical software partition 44 and at least one management software partition 48 over the predefined duration.

It is then necessary to characterize the execution time required to execute at least one critical software partition 44 to ensure that the predefined duration is sufficient.

The hypervisor 34 is configured to generate and execute a management software partition 48 using at least a portion of the associated hardware resources 20.

Typically, the hypervisor 34 is adapted to execute said management software partition 48 between two executions of the scheduling.

The management software partition 48 is configured to receive at least one critical or non-critical function from electronic equipment 8.

For example, at least one critical or non-critical function received is included in the data received by the communication unit 10.

The communication unit 10 is adapted to transmit at least one critical or non-critical function to the management software partition 48.

The management software partition 48 is configured to store at least one critical or non-critical function in the second memory space 32.

The second memory space 32 includes at least one non-critical function stored in a catalog of functions accessible by the management software partition.

The number of critical or non-critical software function(s) stored is then limited only by the storage capacity of said second memory space 32.

Thus, at least a portion of the hardware resources 20 associated with the management software partition 48 includes at least the second memory space 32.

The management software partition 48 is configured to replace the non-critical function of at least one non-critical software partition 46 with a non-critical function stored in the second memory area 32.

The management software partition 48 is also configured to replace the critical function of at least one critical software partition 44 with a critical function stored in the second memory area 32.

Optionally, the management software partition 48 is also configured to delete at least one non-critical software partition 46 and/or at least one critical software partition 44 associated with the non-critical function and/or the critical function that has been replaced.

Alternatively, the data storage resources 26 include a third memory space 36, distinct from the first memory space 30 and the second memory space 32.

The third memory space 36 then includes deleted critical or non-critical functions and/or unsupported or unvalidated operating systems.

Thus, the third memory space 36 is not associated with any of at least one critical software partition 44 or at least one non-critical software partition 46.

The management software partition 48 is configured to instruct the hypervisor 34 to execute, over the predefined duration, at least one critical software partition 44 and at least one non-critical software partition 46.

Optionally, the management software partition 48 is configured to modify the scheduling based on at least one priority criterion associated with at least one non-critical software partition 46 and/or at least one critical software partition 44.

For example, the at least one priority criterion is an execution time criterion, a priority settable by the operator, or the possibility of execution in multiple execution cycles.

Typically, the execution time of at least one non-critical software partition 46 is predefined by the operator and recorded in the data storage resources 26.

Optionally, the management software partition 48 is configured to determine at least one execution parameter representative of the execution quality of the non-critical function of at least one non-critical software partition 46 and/or the critical function of at least one critical software partition 44, with the at least one execution parameter also being a priority criterion.

For example, at the end of the predefined duration, the management software partition 48 receives a plurality of information from at least one non-critical software partition 46 and/or at least one critical software partition 44 and determines the execution time, reliability, and/or availability associated with the execution of at least one critical software partition 44 and/or at least one non-critical software partition 46, to deduce the at least one execution parameter.

Alternatively, the hypervisor 34 is configured to generate at least two critical software partitions 44 or non-critical software partitions 46.

According to this alternative, the management software partition 48 is advantageously configured to allow data exchanges between at least two critical software partitions 44 or non-critical software partitions 46 according to at least one exchange criterion.

Typically, the at least one exchange criterion is a criterion of availability, integrity, and/or confidentiality between at least two non-critical software partitions 46.

For example, the operator defines the at least one exchange criterion in advance.

The management software partition 48 is certified DAL A according to the DO-178 standard.

Such certification of the management software partition 48 ensures the operation of the avionics device 4 for critical software partitions 44, typically certified DAL A to DAL C, and non-critical software partitions 46, typically certified DAL D to DAL E, without the behavior of said management software partition 48 affecting the critical software partitions 44, and in particular the critical functions.

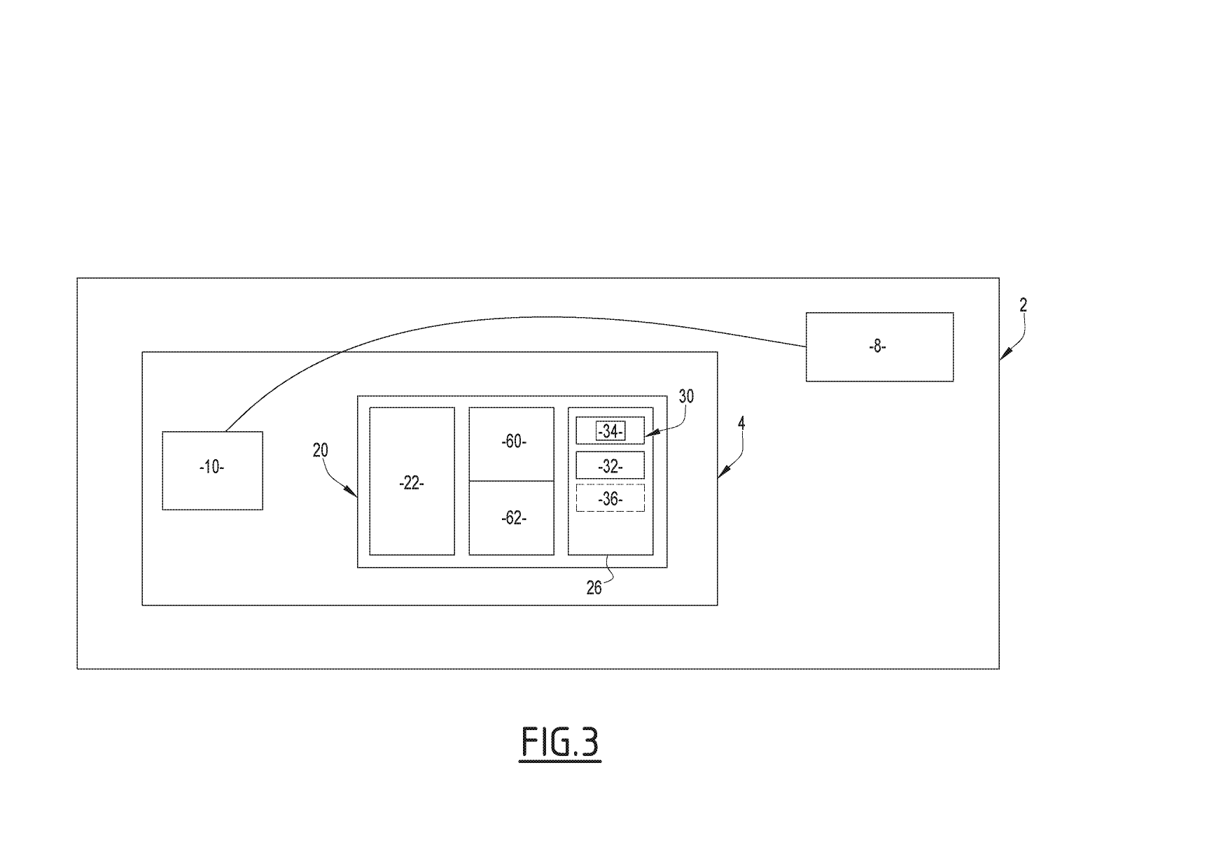

In an alternative represented in FIG. 3, the computing resources 22 include critical computing resources 60 and non-critical computing resources 62 previously set.

At least one critical software partition 44 and the management software partition 48 are associated with the critical computing resources 60.

Furthermore, at least one non-critical software partition 46 is associated with the non-critical computing resources 62.

Such an alternative ensures the physical availability of hardware resources 20 for at least one critical software partition 44 and for the management software partition 48.

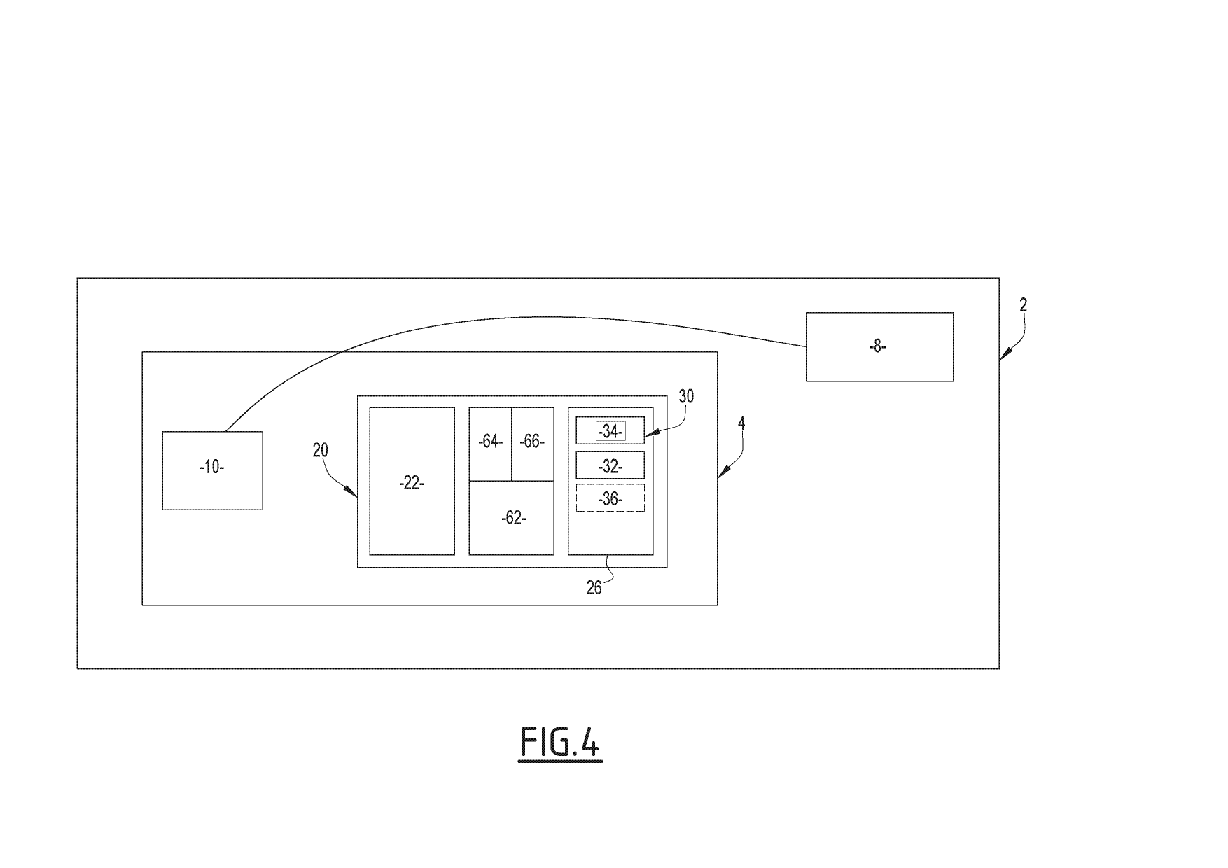

In another example represented in FIG. 4, the critical computing resources 60 include management computing resources 64 and avionics computing resources 66 previously set.

The management software partition 48 is associated with the management computing resources 64.

At least one critical software partition 44 is associated with the avionics computing resources 66.

Such a feature then ensures the physical availability of hardware resources 20 for both at least one critical software partition 44 and the management software partition 48.

Optionally, the avionics device 4 includes a communication gateway 50 between at least one critical software partition 44 and at least one non-critical software partition 46.

For example, the communication gateway 50 is configured to allow data exchange between at least one critical software partition 44 and at least one non-critical software partition 46 according to at least one exchange criterion.

In such an example, the communication gateway 50 is configured to verify the integrity and/or confidentiality of said data exchange, particularly from a non-critical software partition 46 to a critical software partition 44, and interrupt the data exchange if the associated integrity and/or confidentiality is not verified.

The verification of the integrity of a data exchange from a critical software partition 44 to a non-critical software partition 46 is optional and discretionary.

For example, the communication gateway 50 is included in the hypervisor 34.

Alternatively, the communication gateway 50 is external to the avionics device 4, and said avionics device 4 is configured to communicate with said communication gateway 50.

In another alternative, the communication gateway 50 is included in a critical software partition 44 or in a non-critical software partition 46.

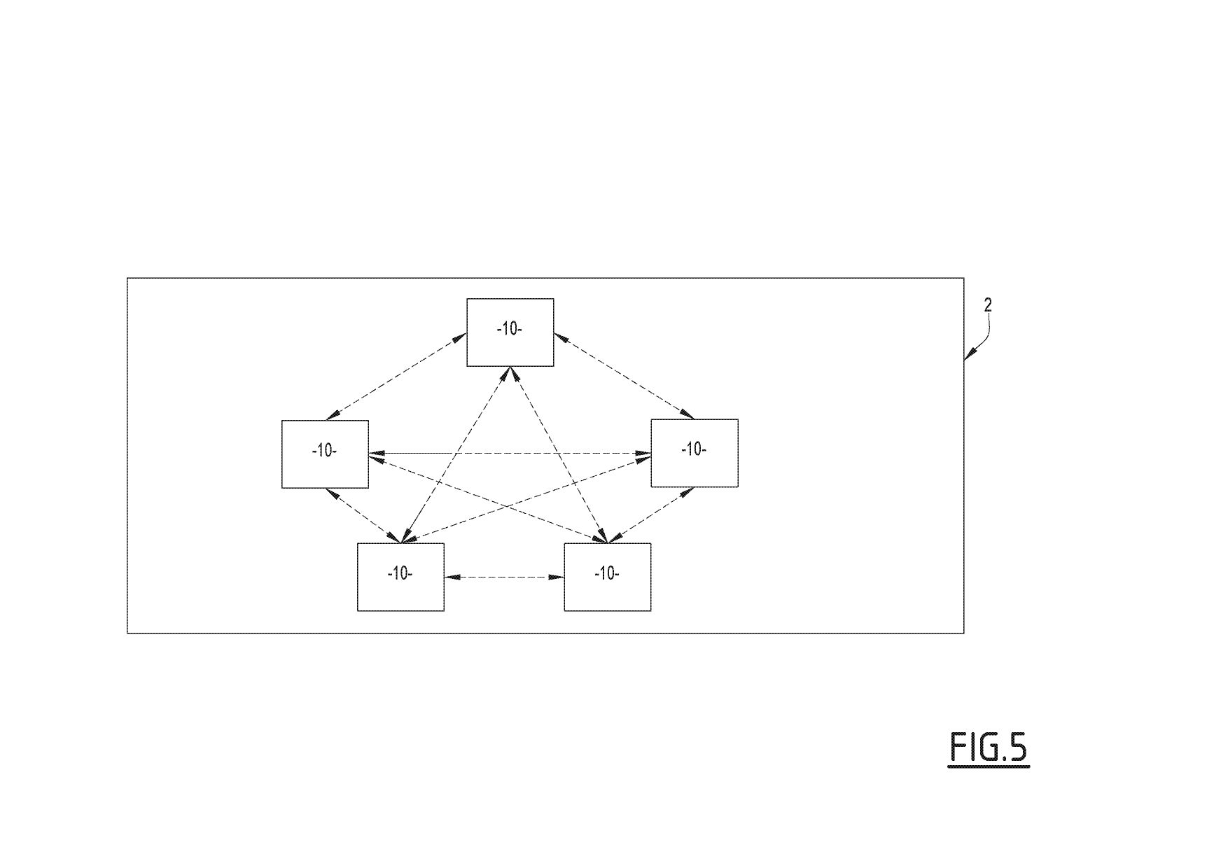

In FIG. 5, the aircraft 2 includes a plurality of avionics devices 4.

Furthermore, at least one of the avionics devices 4 is adapted to store a hypervisor 34 configured to generate and execute a management software partition 48 as previously defined.

Such a configuration makes it possible to introduce a master/slave node system wherein the avionics device(s) 4 configured to generate and execute the management software partition 48 are categorized as master(s).

Thus, the master avionics device(s) 4 introduce the management partition characteristics to all avionics devices 4 via data exchanges.

Optionally, the slave avionics device(s) 4 are categorized based on a certification level associated with at least one critical software partition 44 and at least one non-critical software partition 46.

Such categorization allows the master avionics device(s) 4 to transmit data to the slave avionics device(s) 4 based on said categorization.

Thus, the master avionics device(s) 4 can transmit non-critical functions and store them in the slave avionics device(s) 4.

In response, the slave avionics device(s) 4 transmit the results of the associated critical functions to the master avionics device(s) 4.

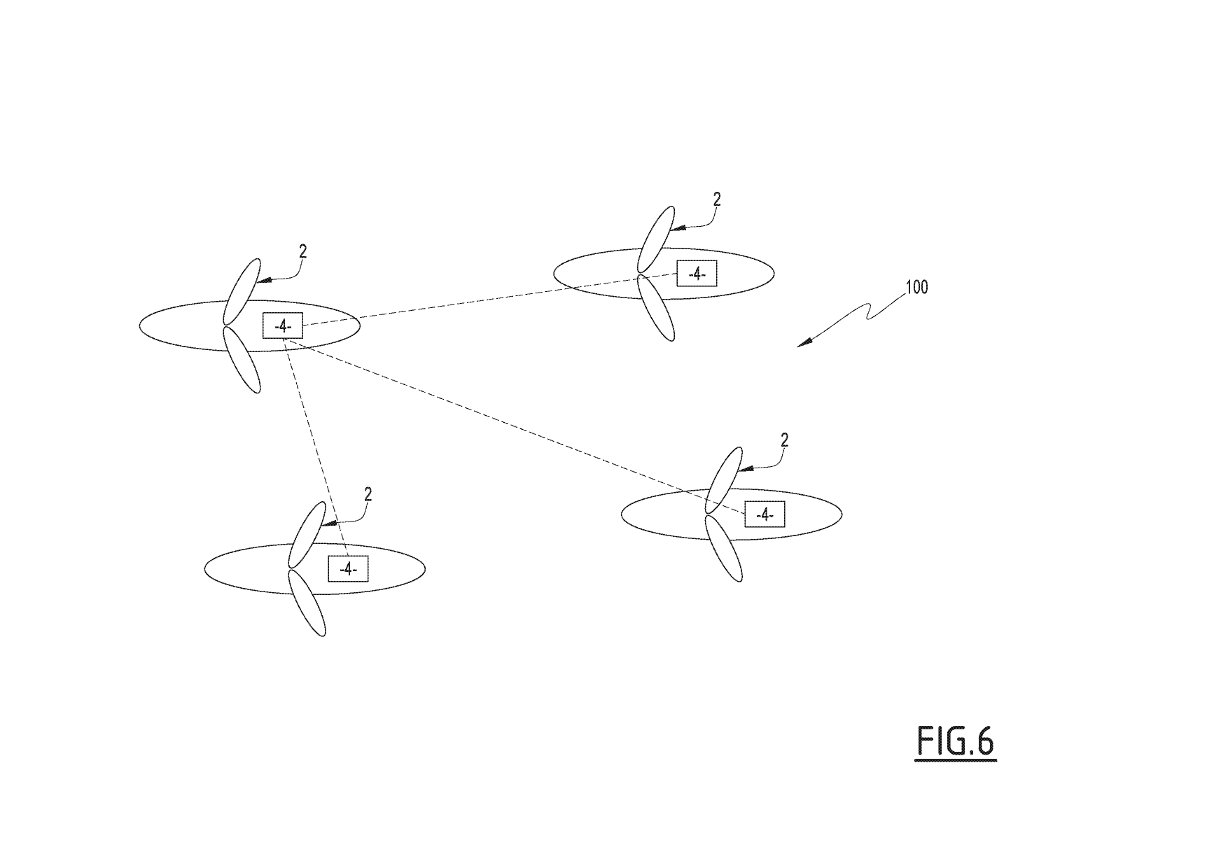

FIG. 6 represents a fleet of aircraft 100 configured to exchange processing data or a software service.

Furthermore, at least one aircraft 2 of said fleet 100 includes the avionics device 4.

Such a configuration then forms a master/slave node system wherein the aircraft 2 including the avionics device 4 are categorized as master.

Thus, the master aircraft 2 implement the characteristics of the avionics device 4 to all aircraft 2 via data exchanges.

Optionally, the slave aircraft 2 are categorized based on a certification level associated with at least one critical software partition 44 and at least one non-critical software partition 46.

Such categorization allows the master aircraft 2 to transmit data to the slave aircraft 2 based on said categorization.

Thus, the master aircraft 2 can transmit non-critical functions and store them in the slave aircraft 2.

In response, the slave aircraft 2 transmit the results of the associated critical functions to the master aircraft 2.

Preferably, all aircraft 2 of said fleet 100 include said avionics device 4.

Such a configuration makes it possible to introduce resilience in the execution of software functions across multiple aircraft 2.

Indeed, in case of unavailability of an avionics device 4 of an aircraft 2, another aircraft 2 of the fleet of aircraft 100 could execute the necessary functions.

1. An avionics electronic device intended to be on board an aircraft, said avionics device comprising at least:
a communication unit configured to exchange data with electronic equipment,hardware resources comprising:computing resources,network resources,data storage resources comprising at least a first memory space wherein a hypervisor is stored, said hypervisor being configured to:generate at least one critical software partition, each critical software partition being configured to execute a critical software function using at least a portion of the associated hardware resources, a critical software function being a function whose malfunction poses a risk to the safety and/or security of the aircraft,generate at least one non-critical software partition, each non-critical software partition being configured to execute a non-critical software function using at least a portion of the associated hardware resources,execute, over a predefined duration, at least one critical software partition and at least one non-critical software partition by allocating to each partition at least a portion of the associated hardware resources and according to a predetermined scheduling,
wherein the hypervisor is further configured to generate and execute a management software partition using at least a portion of the associated hardware resource, said management software partition being configured to:
receive, from electronic equipment, at least one critical or non-critical function,store at least one critical or non-critical function in a second memory space of the data storage resources, the second memory space being distinct from the first memory space,replace the non-critical function of at least one non-critical software partition with a non-critical function stored in the second memory area,replace the critical function of at least one critical software partition with a critical function stored in the second memory area, andinstruct the hypervisor to execute, over the predefined duration, at least one critical software partition and at least one non-critical software partition.

2. The avionics device according to claim 1, wherein the management software partition is further configured to delete at least one non-critical software partition.

3. The avionics device according to claim 1, wherein the management software partition is further configured to delete at least one critical software partition associated with the non-critical function.

4. The avionics device according to claim 1, wherein the management software partition is further configured to delete the critical function that has been replaced.

5. The avionics device according to claim 1, wherein the management software partition is further configured to modify the scheduling based on at least one priority criterion associated with at least one critical software partition and/or at least one non-critical software partition.

6. The avionics device according to claim 1, wherein the at least one priority criterion is an execution time criterion, a priority settable by an operator, or the possibility of execution in multiple execution cycles.

7. The avionics device according to claim 1, wherein the management software partition is further configured to determine at least one execution parameter representative of the execution quality of the non-critical function of at least one non-critical software partition and/or the critical function of at least one critical software partition, with the at least one execution parameter also being a priority criterion.

8. The avionics device according to claim 1, wherein the hypervisor is configured to generate at least two critical software partitions or non-critical software partition.

9. The avionics device according to claim 1, wherein the management software partition is further configured to allow data exchanges between at least two critical software partitions or non-critical software partitions according to at least one exchange criterion.

10. The avionics device according to claim 1, wherein the at least one exchange criterion is a criterion of availability, integrity, and/or confidentiality between at least two non-critical software partitions.

11. The avionics device according to claim 1, wherein the scheduling is adapted to guarantee the execution of at least one critical software partition and at least one management software partition over the predefined duration.

12. The avionics device according to claim 1, wherein the computing resources further include critical computing resource and non-critical computing resources previously set, with at least one critical software partition and the management software partition being associated with the critical computing resources, and at least one non-critical software partition being associated with the non-critical computing resource.

13. The avionics device according to claim 1, wherein the critical computing resources further include management computing resources and avionics computing resources previously set, with the management software partition being associated with the management computing resources and at least one critical software partition being associated with the avionics computing resources.

14. The avionics device according to claim 1, further including a communication gateway between at least one critical software partition and at least one non-critical software partition, said communication gateway being configured to:
allow data exchange between at least one critical software partition and at least one non-critical software partition according to at least one exchange criterion,
verify the integrity and/or confidentiality of said data exchange, and
interrupt the data exchange if the associated integrity and/or confidentiality is not verified.

15. The avionics device according to claim 14, wherein the communication gateway is included in the hypervisor.

16. The avionics device according to claim 14, wherein the communication gateway is external to the avionics device.

17. The avionics device according to claim 1, wherein the non-critical function intended to be executed by at least one non-critical software partition is included in a container including at least one ancillary function, with the non-critical function requiring at least one ancillary function to be executed.

18. An aircraft comprising an avionics device, wherein said avionics device is according to claim 1.

19. A fleet of aircraft configured to exchange processing data or a software service, with at least one aircraft of said fleet including an avionics device according to claim 18.

20. The fleet of aircraft according to claim 19, wherein all aircraft of said fleet are according to claim 18.
